(19) United States
(12) Patent Application Publication
(10) Pub. No.: US 2017/0371669 A1
(43) Pub. Date: Dec. 28, 2017

(54) BRANCH TARGET PREDICTOR

(71) Applicant: QUALCOMM Incorporated, San Diego, CA (US)

(72) Inventors: Anil Krishna, Cary, NC (US); Gregory Wright, Chapel Hill, NC (US)

(21) Appl. No.: 15/192,794

(22) Filed: Jun. 24, 2016

(51) Int. Cl. G06F 9/38; G06F 9/30

(52) U.S. Cl. CPC G06F 9/3806; G06F 9/30058

(57) ABSTRACT

A method for predicting a fetch address of a next instruction to be fetched includes selecting, at a processor, a first way identifier or a second way identifier as a way pointer based on an active fetch address and historical prediction data. A first predictor table includes a first entry having the first way identifier and a second predictor table includes a second entry having the second way identifier. The method also includes selecting a first or second fetch address as a predicted fetch address based on the way pointer. A target table includes a first way storing the first fetch address and a second way storing the second fetch address. The first way and the second way are associated with the active fetch address. The first fetch address is associated with the first way identifier and the second fetch address is associated with the second way identifier.

### I. FIELD

The present disclosure is generally related to a branch target predictor.

### II. DESCRIPTION OF RELATED ART

Advances in technology have resulted in more powerful computing devices. For example, there currently exists a variety of computing devices, including wireless computing devices, such as portable wireless telephones, personal digital assistants (PDAs), and paging devices that are small, lightweight, and easily carried by users, laptop and desktop computers, and servers.

A computing device may include a processor that is operable to execute different instructions in an instruction set (e.g., a program). The instruction set may include direct branches and indirect branches. An indirect branch may specify the fetch address of the next instruction to be executed from an instruction memory. The next instruction may be indirectly fetched because the instruction address is resident in some other storage element (e.g., a processor register). Thus, the indirect branch may not embed the offset to the address of the target instruction within one of the instruction fields in the branch instruction. Non-limiting examples of an indirect branch include a computed jump, an indirect jump, and a register-indirect jump. In order to attempt to increase performance at the processor, the processor may predict the fetch address. To predict the fetch address, the processor may use multiple predictor tables, where each predictor table includes multiple prediction entries, and where each prediction entry stores a fetch address.

Because each prediction entry stores an entire fetch address and multiple prediction tables may include similar entries, in certain scenarios, there may be a relatively large amount of overhead at each predictor table. For example, each prediction entry in a predictor table may not be used by an application, multiple predictor tables may include identical predictor entries (e.g., target duplication), and the number of predictor table entries may not be capable of adjustment independently from the number of target instructions.

The processor may also utilize a stored global history from past indirect branches to predict the fetch address. For example, the processor may predict the fetch address based on predicted fetch addresses for the previous ten indirect branches to provide context. Each fetch address stored in the global history may utilize approximately ten bits of storage. For example, twenty previously predicted fetch addresses stored in the global history may utilize approximately two-hundred bits of storage. Thus, a relatively large amount of storage may be used for the global history.

### III. SUMMARY

According to one implementation of the present disclosure, an apparatus for predicting a fetch address of a next instruction to be fetched includes a memory system, first selection logic, and second selection logic. The memory system includes a plurality of predictor tables and a target table. The plurality of predictor tables includes a first predictor table and a second predictor table. The first predictor table includes a first entry having a first way identifier, and the second predictor table includes a second entry having a second way identifier. The target table includes a first way that stores a first fetch address associated with the first way identifier and a second way that stores a second fetch address associated with the second way identifier. The first way and the second way are associated with an active address. According to one implementation, the first way identifier and the second way identifier may “point” to a similar way. According to another implementation, the first way identifier and the second way identifier may point to different ways. The first selection logic is coupled to select the first way identifier or the second way identifier as a way pointer based on the active fetch address and historical prediction data. The second selection logic is configured to select the first fetch address or the second fetch address as a predicted fetch address based on the way pointer. By using a separate table (e.g., the target table) to store multiple fetch addresses as opposed to storing multiple (and sometimes identical) fetch addresses at different predictor tables, an amount of overhead may be reduced. Additionally, the historical prediction data may include an “abbreviated version” of the previously used fetch addresses (e.g., some bits of previously used fetch addresses) as opposed to the entire fetch addresses, data associated with way identifiers of the previously used fetch addresses, or a combination of both. The most significant bits of a fetch address may not substantially change from one fetch address to another fetch address. Lower order bits (or a hash function) may be used to reduce a particular fetch address into a smaller number of bits. According to one example, the historical prediction data may include a way number (e.g., a way identifier) in the target table for each previously used fetch address. Thus, instead of 64-bit previously used fetch addresses, the historical prediction data may include some bits (e.g., three to five bits) for each previously used fetch address and a relatively small number of bits (e.g., two to three bits) to identify the way of each previously used fetch address. This reduction in bits may reduce the overhead at the processing system compared conventional processing systems for predicting a fetch address of a target instruction.

According to another implementation of the present disclosure, a method for predicting a fetch address of a next instruction to be fetched includes selecting, at a processor, a first way identifier or a second way identifier as a way pointer based on an active fetch address and historical prediction data. A first predictor table includes a first entry having the first way identifier and a second predictor table includes a second entry having the second way identifier. The method also includes selecting a first fetch address or a second fetch address as a predicted fetch address based on the way pointer. A target table includes a first way storing the first fetch address and a second way storing the second fetch address. The first way and the second way are associated with the active fetch address. The first fetch address is associated with the first way identifier and the second fetch address is associated with the second way identifier.

According to another implementation of the present disclosure, a non-transitory computer-readable medium includes commands for predicting a fetch address of a next instruction to be fetched. The commands, when executed by a processor, cause the processor to perform operations including selecting a first way identifier or a second way identifier as a way pointer based on an active fetch address and historical prediction data. A first predictor table includes a first entry having the first way identifier and a second predictor table includes a second entry having the second way identifier. The operations also include selecting a first fetch address or a second fetch address as a predicted fetch address based on the way pointer. A target table includes a first way storing the first fetch address and a second way storing the second fetch address. The first way and the second way are associated with the active fetch address. The first fetch address is associated with the first way identifier and the second fetch address is associated with the second way identifier.

According to another implementation of the present disclosure, an apparatus for predicting a fetch address of a next instruction to be fetched includes means for storing data. The means for storing data includes a plurality of predictor tables and a target table. The plurality of predictor tables includes a first predictor table and a second predictor table. The first predictor table includes a first entry having a first way identifier, and the second predictor table includes a second entry having a second way identifier. The target table includes a first way that stores a first fetch address associated with the first way identifier and a second way that stores a second fetch address associated with the second way identifier. The first way and the second way are associated with an active address. The apparatus also includes means for selecting the first way identifier or the second way identifier as a way pointer based on the active fetch address and historical prediction data. The apparatus also includes means for selecting the first fetch address or the second fetch address as a predicted fetch address based on the way pointer.

### IV. BRIEF DESCRIPTION OF THE DRAWINGS

FIG. 1 is a processing system that it operable to predict a fetch address of a target instruction;

FIG. 2 depicts predictor tables included in the processing system of FIG. 1;

FIG. 3 is a method for predicting a fetch address of a target instruction; and

FIG. 4 is a block diagram of a device that includes the processing system of FIG. 1.

### V. DETAILED DESCRIPTION

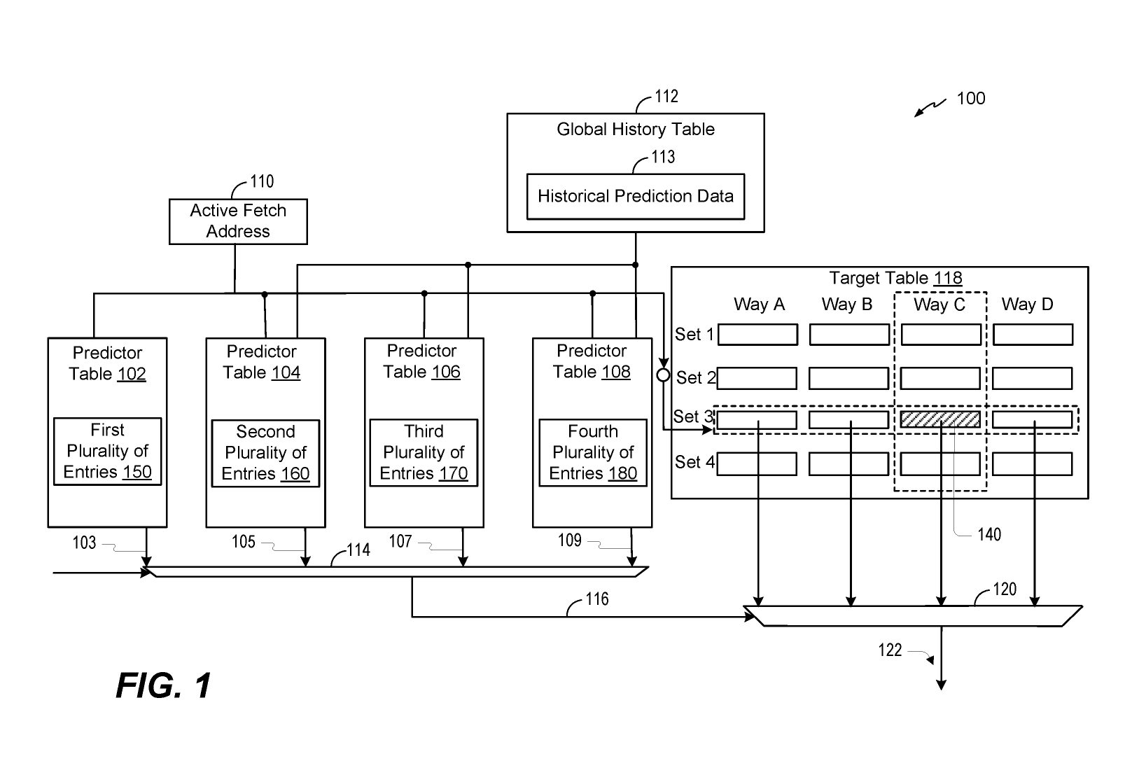

Referring to FIG. 1, a processing system 100 that is operable to predict a fetch address of a target instruction is shown. As used herein, a fetch address corresponds to a location in memory where an address for the target instruction (e.g., the next instruction to be executed) is stored. The processing system 100 may also be referred to as a “memory system.”

As explained below, the processing system 100 may predict the fetch address of the target instruction based on an active fetch address 110. According to one implementation, the active fetch address 110 may be based on a current program counter (PC) value. The processing system 100 includes a plurality of predictor tables, a global history table 112, first selection logic 114, a target table 118, and second selection logic 120. According to one implementation, the first selection logic 114 includes a first multiplexer and the second selection logic 120 includes a second multiplexer.

The plurality of predictor tables includes a predictor table 102, a predictor table 104, a predictor table 106, and a predictor table 108. Although four predictor tables 102-108 are shown, in other implementations, the processing system 100 may include additional (or fewer) predictor tables. As a non-limiting example, the processing system 100 may include eight predictor tables in another implementation.

Each predictor table 102-108 includes multiple entries that identify different fetch addresses. For example, the predictor table 102 includes a first plurality of entries 150, the predictor table 104 includes a second plurality of entries 160, the predictor table 106 includes a third plurality of entries 170, and the predictor table 108 includes a fourth plurality of entries 180. According to one implementation, different predictor tables 102-108 may have different sizes. To illustrate, different predictor tables 102-108 may have a different number of entries. As a non-limiting example, the fourth plurality of entries 180 may include more entries than the second plurality of entries 160.

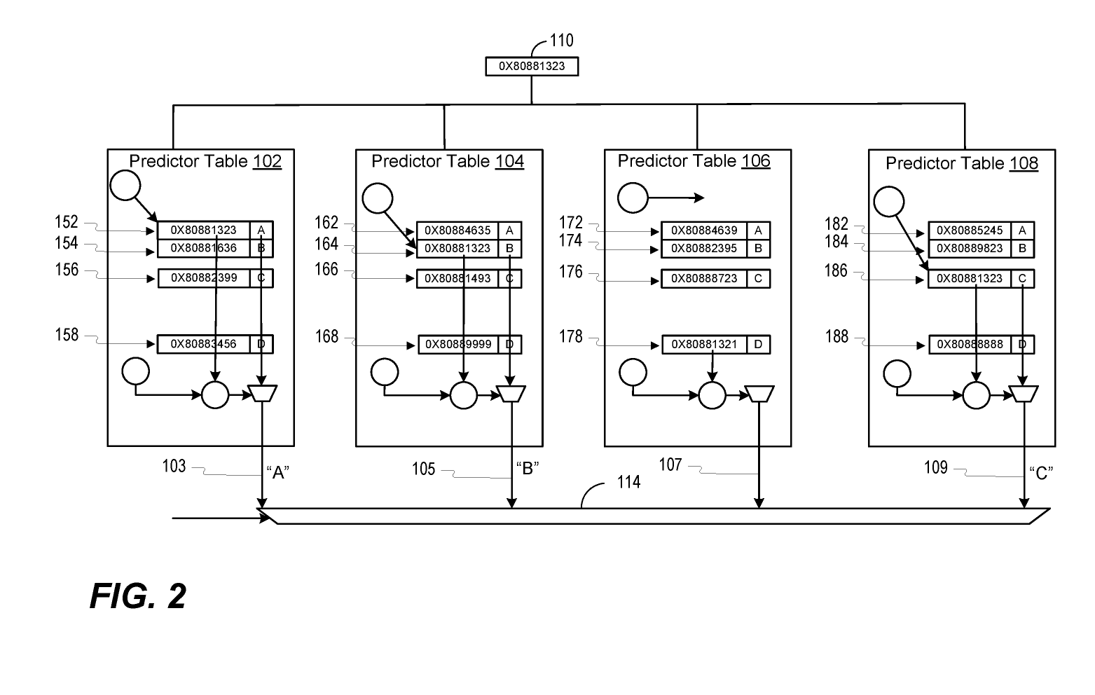

The predictor tables 102-108 of the processing system 100 are shown in greater detail in FIG. 2. The active fetch address 110 is provided to each predictor table 102-108 to determine whether a “hit” exists at the predictor tables 102-108. For example, the processing system 100 may determine whether each predictor table 102-108 includes an entry that matches the active fetch address 110. According to the example illustrated in FIG. 2, the active fetch address 110 is “0X80881323”. It should be understood that the active fetch address 110 (and other addresses described herein) is merely for illustrative purposes and should not be construed as limiting.

The predictor table 102 includes an entry 152, an entry 154, an entry 156, and an entry 158. According to one implementation, each entry 152-158 may be included in the first plurality of entries 150 of FIG. 1. The entry 152 may include a tag “0X80881323” and may include a way identifier “A”, the entry 154 may include a tag “0X80881636” and may include a way identifier “B”, the entry 156 may include a tag “0X80882399” and may include a way identifier “C”, and the entry 158 may include a tag “0X80883456” and may include a way identifier “D”. According to one implementation, each tag may include a subset of a fetch address hashed together with other information (e.g., a particular number of previously seen fetch addresses). Each tag may include enough information such that remainder of the entry's content is associated with a fetch address looking up for that entry. Thus, each tag may be used as an identification mechanism for a fetch address. For ease of illustration, the way identifiers are identified by a single capitalized letter.

The predictor table 104 includes an entry 162, an entry 164, an entry 166, and an entry 168. According to one implementation, each entry 162-168 may be included in the second plurality of entries 160 of FIG. 1. The entry 162 may include a tag “0X80884635” and may include the way identifier “A”, the entry 164 may include a tag “0X80881323” and may include the way identifier “B”, the entry 166 may include a tag “0X80881493” and may include the way identifier “C”, and the entry 168 may include a tag “0X80889999” and may include the way identifier “D”.

The predictor table 106 includes an entry 172, an entry 174, an entry 176, and an entry 178. According to one implementation, each entry 172-178 may be included in the third plurality of entries 170 of FIG. 1. The entry 172 may include a tag “0X80884639” and may include the way identifier “A”, the entry 174 may include a tag “0X80882395” and may include the way identifier “B”, the entry 176 may include a tag “0X80888723” and may include the way identifier “C”, and the entry 178 may include a tag “0X80881321” and may include the way identifier “D”.

The predictor table 108 includes an entry 182, an entry 184, an entry 186, and an entry 188. According to one implementation, each entry 182-188 may be included in the fourth plurality of entries 180 of FIG. 1. The entry 182 may include a tag “0X80885245” and may include the way identifier “A”, the entry 184 may include a tag

“0X80889823” and may include the way identifier “B”, the entry 186 may include a tag “0X80881323” and may include the way identifier “C”, and the entry 188 may include a tag “0X80888888” and may include the way identifier “D”.

A processor (e.g., in the processing system 100 of FIG. 1) may determine that the entry 152 in the predictor table 102 matches the active fetch address 110. Based on this determination, the processor may provide the way identifier “A” to the first selection logic 114 as an output tag indicator 103 of the predictor table 102. The processor may also determine that the entry 164 in the predictor table 102 matches the active fetch address 110. Based on this determination, the processor may provide the way identifier “B” to the first selection logic 114 as an output tag indicator 105 of the predictor table 102.

The processor may determine that there are no entries in the predictor table 106 that match the active fetch address 110. Thus, the processor may not provide a way identifier to the first selection logic 114 as an output tag indicator 107 of the predictor table 106. The processor may determine that the entry 186 in the predictor table 108 matches the active fetch address 110. Based on this determination, the processor may provide the way identifier “C” to the first selection logic 114 as an output tag indicator 109 of the predictor table 108.

In the illustrative example, each output tag indicator 103, 105, 107, 109 provides a different way identifier to the first selection logic 114. The first selection logic 114 may be configured to select the output tag indicator of the predictor table that has an entry matching the active fetch address 110 and that utilizes a largest amount of historical prediction data (associated with the global history table 112), as explained below. As described above, the output tag indicators 103, 105, 109 correspond to entries 152, 164, 186, respectively, having tags identify the active fetch address 110. Thus, as explained below, the first selection logic 114 may determine which output tag indicator 103, 105, 109 to select based on the amount of historical prediction data associated with each output tag indicator 103, 105, 109. In a scenario where only one output tag indicator corresponds to an entry having a tag identifies the active fetch address 110, the first selection logic 114 may select that output tag indicator.

Referring back to FIG. 1, the global history table 112 includes (e.g., stores) historical prediction data 113. The historical prediction data 113 includes a history of previous fetch addresses for indirect branches. For example, the historical prediction data 113 may include data to identify fetch addresses for previous indirect branches and way numbers associated with the fetch addresses. Each fetch address in the historical prediction data 113 may be an “abbreviated version” of a fetch address, to reduce overhead. For example, the historical prediction data 113 may store some bits (e.g., a subset) of each previous fetch address as opposed to the entire fetch address. The historical prediction data 113 may include a way number (e.g., a way identifier) in the target table 118 for each previously used fetch address. Thus, instead of 64-bit previously used fetch addresses, the historical prediction data 113 may include some bits (e.g., three to five bits) for each previously used fetch address and a relatively small number of bits (e.g., two to three bits) to identify the way of each previously used fetch address.

The processing system 100 may provide the historical prediction data 113 to the predictor table 104, to the predictor table 106, and to the predictor table 108. For example, the processing system 100 may provide a first amount of the historical prediction data 113 to the predictor table 104 with the active fetch address 110 to generate the output tag indicator 105, the processing system 100 may provide a second amount of the historical prediction data 113 (that is greater than the first amount) to the predictor table 106 with the active fetch address 110 to generate the output tag indicator 107, and the processing system 100 may provide a third amount of the historical prediction data 113 (that is greater than the second amount) to the predictor table 104 with the active fetch address 110 to generate the output tag indicator 109.

Because the processing system 100 generates the output tag indicator 103 from the predictor table 102 based solely on the active fetch address 110, the output tag indicator 103 may not be as reliable as the output tag indicators 105, 107, 109 that are generated based on increasing amounts of the historical prediction data 113. Furthermore, because the output tag indicator 107 is generated using more of the historical prediction data 113 than the amount of historical prediction data 113 used to generate the output tag indicator 105, the output tag indicator 107 may be more reliable than the output tag indicator 105. Similarly, because the output tag indicator 109 is generated using more of the historical prediction data 113 than the amount of historical prediction data 113 used to generate the output tag indicator 107, the output tag indicator 109 may be more reliable than the output tag indicator 107.

In the example illustrated in FIG. 2, the output tag indicators 103, 105, 109 correspond to entries 152, 164, 186, respectively, having tags that identify the active fetch address 110. Thus, the first selection logic 114 may determine which output tag indicator 103, 105, 109 to select based on the amount of historical prediction data 113 associated with each output tag indicator 103, 105, 109. Because the output tag indicator 109 is associated with more historical prediction data 113 than the other output tag indicators 103, 105, the first selection logic 114 may select that output tag indicator 109 as a selected way pointer 116. The processing system 100 may provide the selected way pointer 116 to the second selection logic 120.

The target table 118 includes multiple fetch addresses that are separated by sets (e.g., rows) and ways (e.g., columns). In the illustrative example, the target table 118 includes four sets (e.g., “Set 1”, “Set 2”, “Set 3”, and “Set 4”). The target table 118 may also include four ways (e.g., “Way A”, “Way B”, “Way C”, and “Way D”). Although the target table 118 is shown to include four sets and four ways, in other implementations, the target table 118 may include additional (or fewer) ways and sets. As a non-limiting example, target table 118 may include sixteen sets and thirty-two ways.

The processing system 100 may provide the active fetch address 110 to the target table 118. The active fetch address 110 may indicate a particular set of fetch addresses in the target table 118 to be selected. In the illustrative example of FIG. 1, the active fetch address 110 indicates that “Set 3” is where the predicted fetch address 140 is located in the target table 118.

Each way in the target table 118 corresponds to a particular way identifier in the predictor tables 102-108. As described with respect to the example in FIG. 2, each entry in the predictor tables 102-108 can include way identifier “A”, way identifier “B”, way identifier “C”, or way identifier “D”. The entries that include way identifier “A” are associated with “Way A”, the entries that include way identifier “B” are associated with “Way B”, the entries that include way identifier “C” are associated with “Way C”, and the entries that include way identifier “D” are associated with “Way D”. Because the first selection logic 114 selected the output tag indicator 109 as the selected way pointer 116 and the output tag indicator 109 corresponds to the way identifier “C” (e.g., the way identifier of associated with the entry 186), the second selection logic 120 may select “Way C” as the selected way of the predicted fetch address 140.

Thus, the second selection logic 120 may select the predicted fetch address 140 in the table 118 as a fetch address 122 for a target instruction based on the way indicated by the selected way pointer 116 and the set indicated by the active fetch address 110. The fetch address 122 may be used by the processing system to locate the address of the next instruction to be executed (e.g., the target instruction).

The techniques described with respect to FIGS. 1-2 may reduce an amount of overhead (compared to the overhead of a conventional processing system for predicting a fetch address of a target instruction). For example, by using a separate table (e.g., the target table) to store multiple fetch addresses as opposed to storing multiple (and sometimes identical) fetch addresses at different predictor tables, the amount of overhead may be reduced. Additionally, the global history table 112 may include reduced overhead (compared to a conventional processing system) because the global history table 112 stores an “abbreviated version” of the previously used fetch addresses (e.g., stores the most significant bits of previously used fetch addresses) as opposed to the entire addresses. This reduction in bits may reduce the amount of overhead at the processing system compared conventional processing systems for predicting a fetch address of a target instruction. The techniques described with respect to FIGS. 1-2 may also utilize an efficient methodology to determine the way of the predicted fetch address 140 in the target table 118. For example, the techniques may use the predictor tables 102-108 (e.g., the way identifier in the predictor tables 102-108) to determine the selected way of the predicted fetch address 140 in the target table 118.

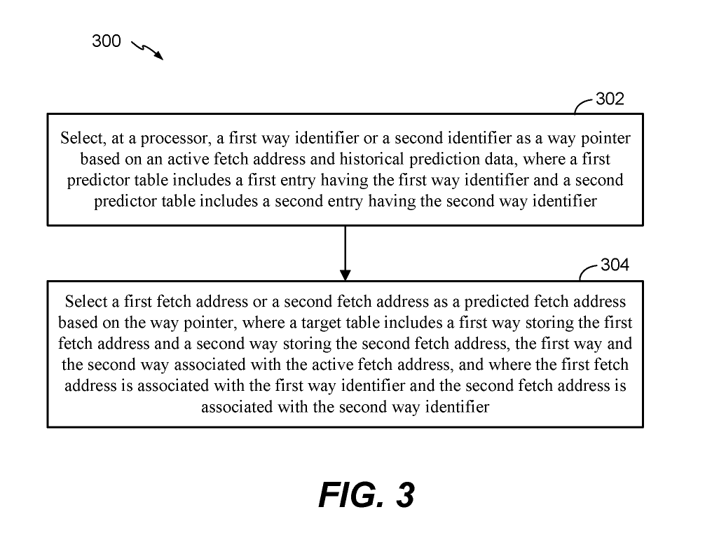

Referring to FIG. 3, a method 300 for predicting a fetch address of a next instruction to be fetched is shown. The method 300 may be performed by the processing system 100 of FIG. 1.

The method 300 includes selecting, at a processor, a first way identifier or a second way identifier as a way pointer based on an active fetch address and historical prediction data, at 302. A first predictor table includes a first entry having the first way identifier and a second predictor table includes a second entry having the second way identifier. For example, referring to FIGS. 1-2, the first selection logic 114 may select way identifier “A”, way identifier “B”, way identifier “C”, or way identifier “D” as the selected way pointer 116 based on the active fetch address 110 and the historical prediction data 113. The predictor table 102 includes the selected entry 152 having way identifier “A”, the predictor table 104 includes the selected entry 164 having way identifier “B”, the predictor table 106 includes the selected entry 178 having way identifier “D”, and the predictor table 108 includes the selected entry 186 having way identifier “C”.

The method 300 also includes selecting a first fetch address or a second fetch address as a predicted fetch address based on the way pointer, at 304. A target table includes a first way storing the first fetch address and a second way storing the second fetch address. The first way and the second way may be associated with the active fetch address. The first fetch address is associated with the first way identifier and the second fetch address is associated with the second way identifier. For example, referring to FIGS. 1-2, the second selection logic 120 select the fetch address associated with the entry 186 as the predicted fetch address 140 based on the selected way pointer 116.

According to one implementation of the method 300, the first selection logic 114 includes a first multiplexer, and the second selection logic 120 includes a second multiplexer. The method 300 may also include storing the historical prediction data 113 at the global history table 112 that is accessible to the processor (e.g., the processing system 100). The historical prediction data 113 includes one or more fetch addresses for one or more previous indirect branches. The method 300 may also include storing most significant bits of each fetch address of the one or more fetch addresses at the global history table to reduce overhead.

According to one implementation, the method 300 includes generating the first entry based on a first amount of the historical prediction data. For example, the entries 162-168 in the predictor table 104 may be generated based on the first amount of the historical prediction data 113. The method 300 may also include generating the second entry based on a second amount of the historical prediction data that is greater than the first amount of the historical prediction data. For example, the entries 172-178 in the predictor table 106 may be generated based on the second amount of the historical prediction data 113 that is greater than the first amount of the historical prediction data 113. According to one implementation, the method 300 includes selecting the second way identifier as the way pointer if the second entry (e.g., the entry generated on a larger amount of the historical prediction data) matches the active fetch address. The method 300 may also include selecting the first way identifier as the way pointer if the second entry fails to match the active fetch address and the first entry matches the active fetch address.

The method 300 of FIG. 3 may reduce an amount of overhead (compared to the overhead of a conventional processing system for predicting a fetch address of a target instruction). For example, by using a separate table (e.g., the target table) to store multiple fetch addresses as opposed to storing multiple (and sometimes identical) fetch addresses at different predictor tables, the amount of overhead may be reduced. Additionally, the global history table 112 may include reduced overhead (compared to a conventional processing system) because the global history table 112 stores an “abbreviated version” of the previously used fetch addresses (e.g., stores the most significant bits of previously used fetch addresses) as opposed to the entire addresses. This reduction in bits may reduce the amount of overhead at the processing system compared conventional processing systems for predicting a fetch address of a target instruction. The method 300 may also efficiently determine the way of the predicted fetch address 140 in the target table 118. For example, the techniques may use the predictor tables 102-108 (e.g., the way identifier in the predictor tables 102-108) to determine the selected way of the predicted fetch address 140 in the target table 118.

In particular implementations, the method 300 of FIG. 3 may be implemented via hardware (e.g., a field-programmable gate array (FPGA) device, an application-specific integrated circuit (ASIC), etc.) of a processing unit, such as a central processing unit (CPU), a digital signal processor (DSP), or a controller, via a firmware device, or any combination thereof. As an example, the method 300 can be performed by a processor that executes instructions.

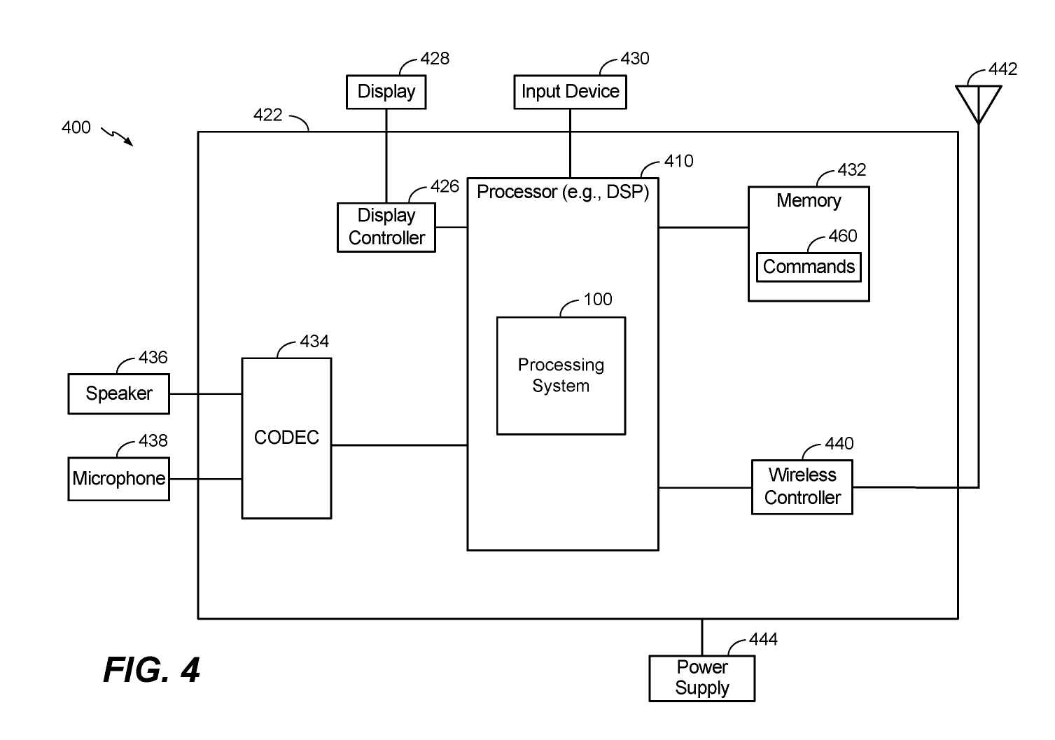

Referring to FIG. 4, a block diagram of a device 400 is depicted. The device 400 includes a processor 410 (e.g., a central processing unit (CPU), a digital signal processor (DSP), etc.) coupled to a memory 432. The processor 410 may include the processing system 100 of FIG. 1.

The memory 432 may be a memory device, such as a random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). The memory device may include commands (e.g., the commands 460) that, when executed by a computer (e.g., processor 410), may cause the computer to perform the method 300 of FIG. 3.

FIG. 4 also shows a display controller 426 that is coupled to the processor 410 and to a display 428. An encoder/decoder (CODEC) 434 may be coupled to the processor 410, as shown. A speaker 436 and a microphone 438 can be coupled to the CODEC 434. FIG. 4 also shows a wireless controller 440 coupled to the processor 410 and to an antenna 442. In a particular implementation, the processor 410, the display controller 426, the memory 432, the CODEC 434, and the wireless controller 440 are included in a system-in-package or system-on-chip device (e.g., a mobile station modem (MSM)) 422. In a particular implementation, an input device 430, such as a touchscreen and/or keypad, and a power supply 444 are coupled to the system-on-chip device 422. Moreover, in a particular implementation, as illustrated in FIG. 4, the display 428, the input device 430, the speaker 436, the microphone 438, the antenna 442, and the power supply 444 are external to the system-on-chip device 422. However, each of the display 428, the input device 430, the speaker 436, the microphone 438, the antenna 442, and the power supply 444 can be coupled to a component of the system-on-chip device 422, such as an interface or a controller.

In conjunction with the described implementations, an apparatus for predicting a fetch address of a next instruction to be fetched includes means for storing data. For example the means for storing data may include a memory system component (e.g., components storing the tables) of the processing system 100 of FIG. 1, one or more other devices, circuits, modules, or instructions to store data, or any combination thereof. The means for storing data may include a plurality of predictor tables and a target table. The plurality of predictor tables may include a first predictor table and a second predictor table. The first predictor table may include a first entry having a first way identifier, and the second predictor table may include a second entry having a second way identifier. The target table may include a first way that stores a first fetch address associated with the first way identifier and a second way that stores a second fetch address associated with the second way identifier. The first way and the second way may be associated with an active address.

The apparatus may also include means for selecting the first way identifier or the second way identifier as a way pointer based on the active fetch address and historical prediction data. For example, the means for selecting the first way identifier or the second way identifier may include the first selection logic 114 of FIG. 1, one or more other devices, circuits, modules, or instructions to select the first way identifier or the second way identifier, or any combination thereof

The apparatus may also include means for selecting the first fetch address or the second fetch address as a predicted fetch address based on the way pointer. For example, the means for selecting the first fetch address or the second fetch address may include the second selection logic 120 of FIG. 1, one or more other devices, circuits, modules, or instructions to select the first fetch address or the second fetch address, or any combination thereof

The foregoing disclosed devices and functionalities may be designed and configured into computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. The chips are then employed in devices, such as a communications device (e.g., a mobile phone), a tablet, a laptop, a personal digital assistant (PDA), a set top box, a music player, a video player, an entertainment unit, a navigation device, a fixed location data unit, a server, or a computer.

Those of skill would further appreciate that the various illustrative logical blocks, configurations, modules, circuits, and algorithm steps described in connection with the implementations disclosed herein may be implemented as electronic hardware, computer software executed by a processing device such as a hardware processor, or combinations of both. Various illustrative components, blocks, configurations, modules, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in a memory device, such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). An exemplary memory device is coupled to the processor such that the processor can read information from, and write information to, the memory device. In the alternative, the memory device may be integral to the processor. The processor and the storage medium may reside in an application-specific integrated circuit (ASIC). The ASIC may reside in a computing device or a user terminal. In the alternative, the processor and the storage medium may reside as discrete components in a computing device or a user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. An apparatus for predicting a fetch address of a next instruction to be fetched, the apparatus comprising:
a memory system storing:
a plurality of predictor tables including a first predictor table and a second predictor table, the first predictor table including a first entry having a first way identifier and the second predictor table including a second entry having a second way identifier; and
a target table comprising:
a first way storing a first fetch address associated with the first way identifier; and
a second way storing a second fetch address associated with the second way identifier, the first way and the second way associated with an active fetch address;
first selection logic coupled to select the first way identifier or the second way identifier as a way pointer based on the active fetch address and historical prediction data; and
second selection logic configured to select the first fetch address or the second fetch address as a predicted fetch address based on the way pointer.

2. The apparatus of claim 1, wherein the first selection logic comprises a first multiplexer, and wherein the second selection logic comprises a second multiplexer.

3. The apparatus of claim 1, wherein the memory system further comprises a global history table storing the historical prediction data.

4. The apparatus of claim 3, wherein the historical prediction data comprises one or more fetch addresses for one or more previous indirect branches.

5. The apparatus of claim 4, wherein the global history table stores at least a portion of bits of each fetch address of the one or more fetch addresses or a hashed version of the portion of bits.

6. The apparatus of claim 1, wherein the first entry is generated based on a first amount of the historical prediction data, and wherein the second entry is generated based on a second amount of the historical prediction data that is greater than the first amount of the historical prediction data.

7. The apparatus of claim 6, wherein the first selection logic selects the second way identifier as the way pointer if the second entry matches the active fetch address.

8. The apparatus of claim 6, wherein the first selection logic selects the first way identifier as the way pointer if the second entry fails to match the active fetch address and the first entry matches the active fetch address.

9. The apparatus of claim 1, wherein the first predictor table includes a first number of entries, and wherein the second predictor table includes a second number of entries that is different than the first number of entries.

10. The apparatus of claim 1, wherein each way in the target table corresponds to a way identifier in the plurality of predictor tables.

11. A method for predicting a fetch address of a next instruction to be fetched, the method comprising:
selecting, at a processor, a first way identifier or a second way identifier as a way pointer based on an active fetch address and historical prediction data, wherein a first predictor table includes a first entry having the first way identifier and a second predictor table includes a second entry having the second way identifier; and
selecting a first fetch address or a second fetch address as a predicted fetch address based on the way pointer, wherein a target table includes a first way storing the first fetch address and a second way storing the second fetch address, the first way and the second way associated with the active fetch address;
wherein the first fetch address is associated with the first way identifier and the second fetch address is associated with the second way identifier.

12. The method of claim 11, wherein a first multiplexer of the processor selects the first way identifier or the second way identifier, and wherein a second multiplexer of the processor selects the first fetch address or the second fetch address.

13. The method of claim 11, further comprising storing the historical prediction data at a global history table accessible to the processor.

14. The method of claim 13, wherein the historical prediction data comprises one or more fetch addresses for one or more previous indirect branches.

15. The method of claim 14, further comprising storing most significant bits of each fetch address of the one or more fetch addresses at the global history table.

16. The method of claim 11, further comprising:
generating the first entry based on a first amount of the historical prediction data; and
generating the second entry based on a second amount of the historical prediction data that is greater than the first amount of the historical prediction data.

17. The method of claim 16, further comprising selecting the second way identifier as the way pointer if the second entry matches the active fetch address.

18. The method of claim 16, further comprising selecting the first way identifier as the way pointer if the second entry fails to match the active fetch address and the first entry matches the active fetch address.

19. The method of claim 11, wherein the first predictor table includes a first number of entries, and wherein the second predictor table includes a second number of entries that is different than the first number of entries.

20. The method of claim 11, wherein each way in the target table corresponds to a way identifier in the plurality of predictor tables.

21. A non-transitory computer-readable medium comprising commands for predicting a fetch address of a next instruction to be fetched, the commands, when executed by a processor, cause the processor to perform operations comprising:
selecting a first way identifier or a second way identifier as a way pointer based on an active fetch address and historical prediction data, wherein a first predictor table includes a first entry having the first way identifier and a second predictor table includes a second entry having the second way identifier; and
selecting a first fetch address or a second fetch address as a predicted fetch address based on the way pointer, wherein a target table includes a first way storing the first fetch address and a second way storing the second fetch address, the first way and the second way associated with the active fetch address;
wherein the first fetch address is associated with the first way identifier and the second fetch address is associated with the second way identifier.

22. The non-transitory computer-readable medium of claim 21, wherein the operations further comprise storing the historical prediction data at a global history table accessible to the processor.

23. The non-transitory computer-readable medium of claim 22, wherein the historical prediction data comprises one or more fetch addresses for one or more previous indirect branches.

24. The non-transitory computer-readable medium of claim 23, wherein the operations further comprise storing most significant bits of each fetch address of the one or more fetch addresses at the global history table.

25. The non-transitory computer-readable medium of claim 21, wherein the operations further comprise:
generating the first entry based on a first amount of the historical prediction data; and
generating the second entry based on a second amount of the historical prediction data that is greater than the first amount of the historical prediction data.

26. The non-transitory computer-readable medium of claim 25, wherein the operations further comprise selecting the second way identifier as the way pointer if the second entry matches the active fetch address.

27. The non-transitory computer-readable medium of claim 25, wherein the operations further comprise selecting the first way identifier as the way pointer if the second entry fails to match the active fetch address and the first entry matches the active fetch address.

28. An apparatus for predicting a fetch address of a next instruction to be fetched, the apparatus comprising:
means for storing data comprising:
a plurality of predictor tables including a first predictor table and a second predictor table, the first predictor table including a first entry having a first way identifier and the second predictor table including a second entry having a second way identifier; and
a target table comprising:
a first way storing a first fetch address associated with the first way identifier; and
a second way storing a second fetch address associated with the second way identifier, the first way and the second way associated with an active fetch address;
means for selecting the first way identifier or the second way identifier as a way pointer based on the active fetch address and historical prediction data; and
means for selecting the first fetch address or the second fetch address as a predicted fetch address based on the way pointer.

29. The apparatus of claim 28, further comprising means for storing the historical prediction data.

30. The apparatus of claim 28, wherein the means for selecting the first way identifier or the second way identifier comprises a first multiplexer, and wherein the means for selecting the first fetch address or the second fetch address comprises a second multiplexer.
